(19) United States
(12) Patent Application Publication
(10) Pub. No.: US 2012/0006769 A1
(43) Pub. Date: Jan. 12, 2012

(54) CROCKERY BASKET AND CROCKERY BASKET SYSTEM

(75) Inventors: Günter Kaps, Altenmunster (DE); Reinhold Lader, Altenmunster (DE); Michael Georg Rosenbauer, Reimlingen (DE); Bernd Schessl, Dillingen (DE)

(73) Assignee: BSH BOSCH UND SIEMENS HAUSGERATE GMBH, Munich (DE)

(21) Appl. No.: 13/165,819

(22) Filed: Jun. 22, 2011

(30) Foreign Application Priority Data
Jul. 9, 2010 (DE) 10 2010 031 171.5

(51) Int. Cl. A47L 15/50; B23P 17/00

(52) U.S. Cl. 211/41.8; 29/428

(57) ABSTRACT

A crockery basket of a dishwasher to accommodate items to be washed includes a basket base piece having at least one open lateral edge area, and at least one separate end piece which is connected to the basket base piece to close the lateral edge area and thereby bound a base area. The end piece can be configured to form a part-surface of the base area or to form no part-surface of the base area.

### BACKGROUND OF THE INVENTION

The invention relates to a crockery basket of a dishwasher to accommodate items to be washed, with a base area.

The use of crockery baskets in dishwashers is known. Dishwashers of different sizes require crockery baskets of different sizes. In order to manufacture different crockery baskets a production facility is required for each crockery basket.

It is an object of the invention to simplify the manufacture of crockery baskets, in that differently sized crockery baskets can be manufactured within one or at least fewer production facilities.

### BRIEF SUMMARY OF THE INVENTION

According to the invention, a basket base piece is provided, which has at least one open lateral edge, which is closed by means of at least one separate end piece connected to the basket base and forming one or no part-surface of the base area. The advantage results therefrom that the basket base piece is closed by means of an end piece, wherein the embodiment of the end piece is adapted to desired requirements in relation to the base area. If the end piece does not form a part-surface of the base area of the crockery basket, then it closes the lateral edge area of the basket base piece, and the base area corresponds to the area which has the basket base piece. The same basket base piece can thus always be manufactured and then connected to the end piece adapted to the requirements. This results in a simplification of the manufacture, as the same production facility can always be used at least for the basket base piece. The base area relates to the bottom surface of the crockery basket, which is enclosed by the closed lateral edge areas. It is conceivable, by means of a multiplicity of end pieces, to embody the depth, height, width and form of the crockery basket in a variable manner. It is thus not only possible to vary the base area, but also to keep the capacity of the crockery basket variable through production technology methods.

According to a development of the invention it is provided that the basket base piece and/or the end piece comprise a grid material, in particular a mesh material, preferably a wire grid. Grid material is particularly suitable for crockery baskets, as they are both highly rigid and easily permeable for washing water and wastewater. It is in particular provided that the grid material comprises wire, preferably metal wire, and is thus embodied as a wire grid. A coating, such as for example of plastic, of the grid material is conceivable, which protects the grid material from corrosion.

According to a development of the invention it is provided that the basket base piece and end piece are welded together. By means of the welding a rapid and secure firmly bonded connection between end piece and basket base piece results.

According to a development of the invention it is provided that the end piece, which does not form a part-surface of the base area, is embodied as a side wall. In the case of embodiment as a side wall, the end piece serves only to close the lateral edge area. In this case the base area of the crockery basket corresponds to the bottom surface which has the basket base piece.

According to a development of the invention it is provided that the end piece, which forms a part-surface of the base area, is embodied as a basket section which has at least one open lateral edge section. Upon manufacture of the crockery basket, the lateral edge area is connected to the open lateral edge section, by means of which the crockery basket is embodied.

The crockery basket is preferably provided with a four-sided, rectangular base area. The base area is then surrounded by four basket walls. The end piece is either embodied as a side wall and is thus used as a basket wall or is embodied as a basket section and in this case likewise forms two parts of two basket walls and one complete basket wall on the crockery basket.

The invention further relates to a crockery basket system of a dishwasher, to accommodate items to be washed. According to the invention, a basket base piece and a multiplicity of differently sized, selectable end pieces are provided, wherein the basket base part together with a end piece forms a crockery basket with a base area, and wherein the multiplicity of end pieces have differently sized part-surfaces of the base area or no part-surface of the base area and the basket base piece has at least one open lateral edge area, which is closed by means of one of the alternatively selectable end pieces. In the case of the crockery basket system a switch in the size of the manufactured crockery baskets can be effected during production in a very rapid and simple manner, in that depending on requirements, a corresponding, as pre-manufactured as possible an end piece, is selected and connected to the basket base piece. It is further conceivable to select a multiplicity of end pieces according to requirements and connect them to the basket base piece, in order also to design the form and height of the crockery basket in a flexible manner.

The invention further relates to a method for the manufacture of a crockery basket of a dishwasher, in particular as claimed in one or several of the preceding claims, to accommodate items to be washed, wherein the crockery basket has a base area. According to the invention the following steps are provided for: Manufacture of a first mat from grid material, manufacture of a basket base piece by means of upward bending of at least one peripheral area, but not all peripheral areas of the first mat, in the latter case to form at least one free lateral edge area, manufacture of a second mat from grid material, manufacture of a end piece in the form of a basket section by means of upward bending of at least one peripheral area of the second mat or in the form of a side wall, connection of basket base piece and end piece and thereby closure of the free lateral edge area. This method of manufacture is characterized by a high degree of flexibility, which allows the manufacture of crockery baskets with differently sized base areas. It is in particular provided that the first mat made of grid material has the same structure and the same material as the second mat made of grid material. The manufacture of the mats can for example take place by means of the crosswise superimposition of two layers of wire rods at a distance from each other and the connection of the two layers to each other. As a result of the fact that not all peripheral areas of the first mat are bent upwards, a free lateral edge area is created. The manufacture of an end piece in the form of a basket section preferably takes place in an appropriate manner such that at least one peripheral area is bent upwards. In the case of a rectangular, four-sided base area it is in particular provided that on the basket base piece, three successive peripheral areas are bent upwards, and in the case of the embodiment of the end piece as a basket section, the basket section is created by means of upward bending, likewise of three peripheral areas of the second mat. The manufacture of the end piece in the form of a side wall can already take place by means of the manufacture of the second mat from grid material, or through an elongation of the second mat. With the connection of basket base piece and end piece it is provided that the free lateral edge area is closed in such a way that the lateral edge section of the basket base piece, or alternatively the side wall, is connected to the lateral edge area.

According to a development of the invention it is provided that at least two adjacent peripheral areas are connected to each other after the upward bending. This can take place after the upward bending of the peripheral areas and/or after the connection of basket base piece and end piece. It is here advantageous that the basket gains stability and stiffness and bending-open of the grid material is effectively prevented.

According to a development of the invention it is provided that the connection takes place by means of welding. This is a simple and highly effective method of creating a firmly bonded connection in particular between basket base piece and end piece and/or between the peripheral areas. In the case of connection by means of welding, it is preferably provided for a coating of the basket base part to be performed after welding.

### BRIEF DESCRIPTION OF THE DRAWINGS

The drawings illustrate the invention and its advantageous developments on the basis of an exemplary embodiment, wherein:

FIG. 1 shows a mat made of grid material, seen from above,

FIG. 2 shows a basket base piece in a perspective view,

FIG. 3 shows an end piece in a first embodiment in a perspective view,

FIG. 4 shows the end piece in a second embodiment in a perspective view,

FIG. 5 shows the end piece in a third embodiment, seen from above,

FIG. 6 shows the basket base piece from FIG. 2 and the end piece from FIG. 4,

FIG. 7 shows a crockery basket, and

FIG. 8 shows a flow chart of the inventive method for manufacture of the crockery basket.

### DETAILED DESCRIPTION OF EXEMPLARY EMBODIMENTS OF THE PRESENT INVENTION

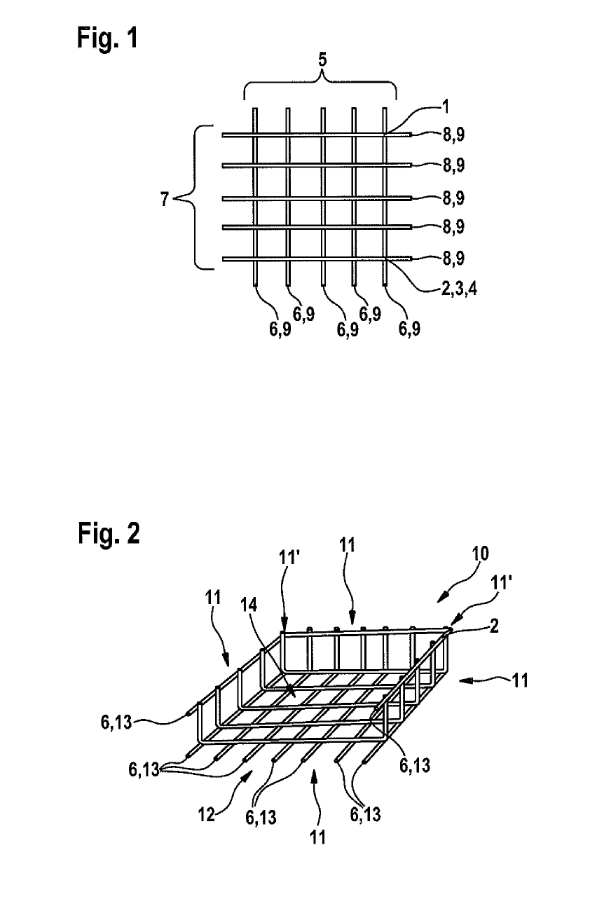

FIG. 1 shows a mat 1 comprising a grid material 2, which exists as mesh material 3 in the form of a wire grid 4. The grid material 2 is formed from a first layer 5 of vertically represented wire rods 6 arranged at a distance from each other. A second layer 7 is formed from a multiplicity of horizontally represented wire rods 8 arranged at a distance from each other. The wire rods 6 and 8 are embodied in metal, preferably iron and/or a ferrous alloy, and as round rods 9.

For manufacture of the mat 1 the wire rods 6 are arranged as represented and the wire rods 8 arranged thereupon in the manner represented, on a “crosswise” basis. Finally the wire rods 6 and 8 are connected to each other, which for example can be effected by means of friction welding.

FIG. 2 shows a basket base piece 10, which has been manufactured from the mat 1 from FIG. 1. For this purpose the mat 1 is first cut to the correct size. The basket base piece 10 has three peripheral areas 11, which are bent upwards in the same direction. As not all peripheral areas 11 are bent upwards, a free lateral edge area 12 is created, which comprises end areas 13 of the wire rods 6. The upwardly bent peripheral areas 11 and the open lateral edge area 12 enclose a bottom surface 14, which is formed from the grid material 2. The term bottom surface 14 should thus not be taken to mean a closed material surface, but the surface which is bounded by the peripheral areas 11 and the open lateral edge area 12. In corner areas 11′ two adjacent peripheral areas 11 are connected to each other, so that the basket base piece 10 gains in stability.

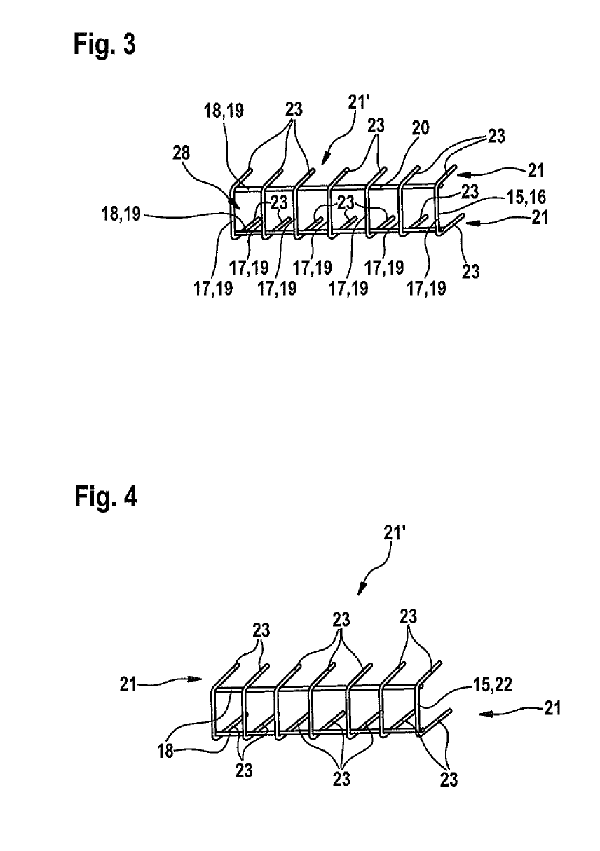

FIG. 3 shows an end piece 15 in a first embodiment 16. The end piece 15 comprises the same material as the basket section 10 from FIG. 2. It comprises U-shaped wire rods 17, which are connected to each other via two straight wire rods 18, arranged at a distance, in terms of height, from each other. Both the wire rods 17 and the wire rods 18 are embodied as round rods 19. By means of the U-shape of the wire rods 17, the end piece 15 is embodied as a basket section 20, which has a part-surface 28, in particular essentially embodied in a horizontal manner, and peripheral areas 21. Through the embodiment as a basket section 20, the end piece 15 has an open lateral edge section 21′, which is formed from the end sections 23 of the wire rods 17.

In order to manufacture the basket section 20, a mat 1, as represented and described in FIG. 1, is created. Starting from the mat 1, two peripheral areas 21 are bent upwards, so that the basket section 20 is created from the mat 1. It is alternatively conceivable that the wire rods 17 are formed into the U-shape in advance and are subsequently connected to the wire rods 18. It is further conceivable that the rods 18 are provided with individual, short wire pieces, which are arranged at a distance from each other in such a way that the first embodiment 16 of the end piece 15 represented in FIG. 3 is produced.

FIG. 4 shows the end piece 15 from FIG. 3 in a second embodiment 22 with all the features from FIG. 3. By contrast to FIG. 3 the end sections 23 are embodied in longer form than the end sections 23 in FIG. 3.

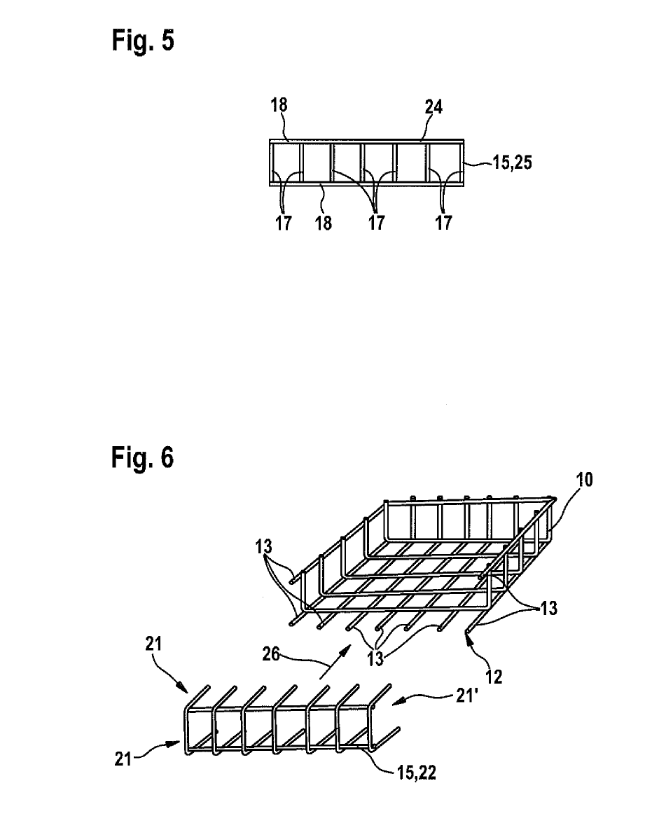

FIG. 5 shows the end piece 15 from FIG. 3 with its features, wherein the wires 17 are embodied without the end areas 23. For the third embodiment 23 of the end piece 15 the embodiment as the side wall 24 which has no part-surface 28 forming the base area of the prepared crockery basket is thus created.

FIG. 6 shows the basket base piece 10 from FIG. 2 with all its features and the end piece 15 in the second embodiment 22 from FIG. 4 with all its features. For connection of the basket base part 10 and of the end piece 15, the open lateral edge section 21′ is shifted to the open lateral edge area 12 in the direction of an arrow 25, in such a way that at least two end areas 13 can in each case be connected to one of the end sections 23 after the shift. The end areas 13 and the end sections 23 are preferably arranged in abutting form, that is to say with their longitudinal extensions lying on a common axis, or overlapping. The connection of the end piece 15 to the basket base piece 10 takes place by means of the welding of the end areas 13 to the end sections 23.

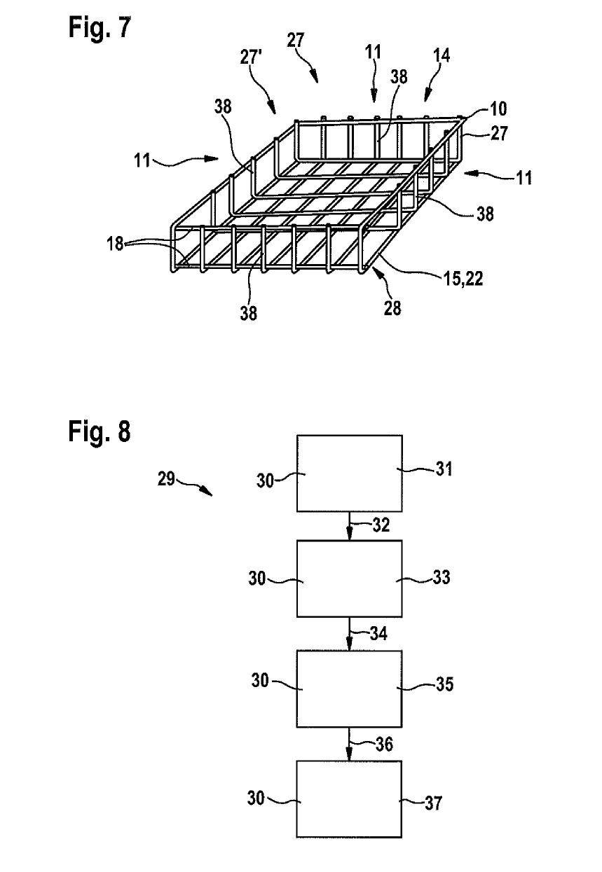

FIG. 7 shows a ready assembled crockery basket 27 for a dishwasher (not shown) to accommodate items to be washed. The crockery basket 27 represented comprises the end piece 15 in the second embodiment 22 and the basket base piece 10 from FIG. 6. The end piece 15 and the basket base piece 10 are connected to each other and those end sections 23 of the end piece 15, which have not been connected to end areas 13 of the basket base part 10, are removed. A base area 27′ thus emerges, which is embodied in four-sided and rectangular in form. The base area 27′ is delimited by the upwardly bent peripheral areas 11 and the wire rods 18. The base area 27′ comprises the part-surface 28, which is formed by the end piece 15 formed and the bottom surface 14 of the basket base piece 10. The upwardly bent peripheral areas 11 and the part of the basket section 20 with and between the rods 18 thus develop into basket walls 38.

The upward bending of the peripheral areas 11 is in particular provided with a 90° angle to the bottom surface 14. The crockery basket 27 thus emerges as a crockery basket with a rectangular basic form and square volume. After the connection of the basket base part 10 to the end piece 15 it can be provided for the entire crockery basket 27 to be coated, in order to prevent corrosion of the crockery basket 27. Such a coating can for example be effected by means of a dip bath.

FIG. 8 shows a flow-chart 29 with individual manufacturing steps 30, which represent the inventive method for manufacture of the crockery basket 27. In a first step 31 manufacture of a mat is performed. In this step 31 the one mat 1 or a multiplicity of mats 1 needed for manufacture of the basket base part 12 and/or of the end piece 15 are created. The manufacture preferably takes place in the manner as described in FIG. 1. The first step 31 transitions into a second step 32 by way of arrow 32, in which the upward bending of the peripheral areas 11 of mat 1 takes place for manufacture of the basket base part 10. This work step is designated as “coffering”. In the same step 32, manufacture of the end piece 15 too is provided for. This can take place either through the arranging of U-shaped wire rods 17 on the wire rods 18 from FIGS. 3 to 5 or through use of one of the mats 1, which is bent upwards in its peripheral areas 21, as described in the FIGS. 3 and 4. The second step 33 transitions into a third step 35 by way of arrow 34. In the third step 35, successive peripheral areas 11 in the peripheral direction around the base area 14 of the basket base piece 10 are welded to each other. This preferably takes place in corner areas 11′. The third step 35 subsequently transitions into a fourth step 37 by way of arrow 36. In the fourth step 37, the manufactured basket end piece 10 is brought together with the manufactured end piece 15, and then welded. In the example shown in FIGS. 1 to 7 the bringing-together takes place in that the end areas 13 are arranged in an abutting manner with the end sections 23, and the abutting end areas 13 welded to the end sections 23. In conclusion superfluous end sections 23, which are not connected to one of the end areas 13, are removed. The manufacture of the crockery basket 27 is thus complete.

What is claimed is:

1. A crockery basket of a dishwasher to accommodate items to be washed, comprising:
a basket base piece having at least one open lateral edge area; and
at least one separate end piece connected to the basket base piece to close the lateral edge area and thereby bound a base area, said end piece being configured in one of two ways, a first way in which the end piece forms a part-surface of the base area, a second way in which the end piece forms no part-surface of the base area.

2. The crockery basket of claim 1, wherein at least one of the basket base piece and the end piece comprises a grid material.

3. The crockery basket of claim 1, wherein at least one of the basket base piece and the end piece comprises a mesh material.

4. The crockery basket of claim 1, wherein at least one of the basket base piece and the end piece comprises a wire grid.

5. The crockery basket of claim 1, wherein the basket base piece and the end piece are welded to each other.

6. The crockery basket of claim 1, wherein the end piece, when forming no part-surface of the base area, is embodied as a side wall.

7. The crockery basket of claim 1, wherein the end piece, when forming the part-surface of the base area, is embodied as a basket section, which has at least one open lateral edge section.

8. A crockery basket system of a dishwasher, to accommodate items to be washed, comprising:
a basket base piece having at least one open lateral edge area; and
a multiplicity of differently sized end pieces selectively connectable to the basket base piece to close the lateral edge area,
wherein the basket base piece forms a crockery basket with a base area together with a selected one of the end pieces, and
wherein the multiplicity of end pieces are dimensioned of different sizes so as to define differently sized part-surfaces of the base area or form no part-surface of the base area.

9. A method for the manufacture of a crockery basket of a dishwasher, to accommodate items to be washed, said method comprising the steps of:
manufacturing a first mat from grid material;
manufacturing a basket base piece by upwardly bending at least one peripheral area, but not all peripheral areas of the first mat so as to establish at least one free lateral edge area;
manufacturing a second mat from grid material;
manufacturing an end piece in the form of a basket section by upwardly bending at least one peripheral area of the second mat or in the form of a side wall; and
connecting the basket base piece and the end piece to thereby close the free lateral edge area.

10. The method of claim 9, wherein at least two adjacent peripheral areas are connected to each other after the upward bending.

11. The method of claim 9, wherein the basket base piece and the end piece are connected by welding.

12. The method of claim 10, wherein the at least two adjacent peripheral areas are connected by welding.
